(19) United States
(12) Patent Application Publication
(10) Pub. No.: US 2014/0123865 A1
(43) Pub. Date: May 8, 2014

(54) METHOD FOR COATING SHEETS WITH A FILM IN A PRINTING PRESS

(71) Applicant: HEIDELBERGER DRUCKMASCHINEN AG, HEIDELBERG (DE)

(72) Inventor: ALEXANDER WEBER, WEINHEIM (DE)

(73) Assignee: HEIDELBERGER DRUCKMASCHINEN AG, HEIDELBERG (DE)

(21) Appl. No.: 14/061,806

(22) Filed: Oct. 24, 2013

(30) Foreign Application Priority Data
Nov. 7, 2012 (DE) 102012021819.2

(51) Int. Cl. B41M 7/00

(52) U.S. Cl. CPC B41M 7/0027
USPC 101/488

(57) ABSTRACT

A method for coating sheets with a film in a printing press includes, in a first step, creating the film in a liquid state on a first cylinder, in a second step, pressing a web of foil onto the film, thus forming a surface of the film, and simultaneously curing the film by irradiation and, in a third step, using the first cylinder to roll the film in a cured state onto a sheet that is transported by a second cylinder during the process.

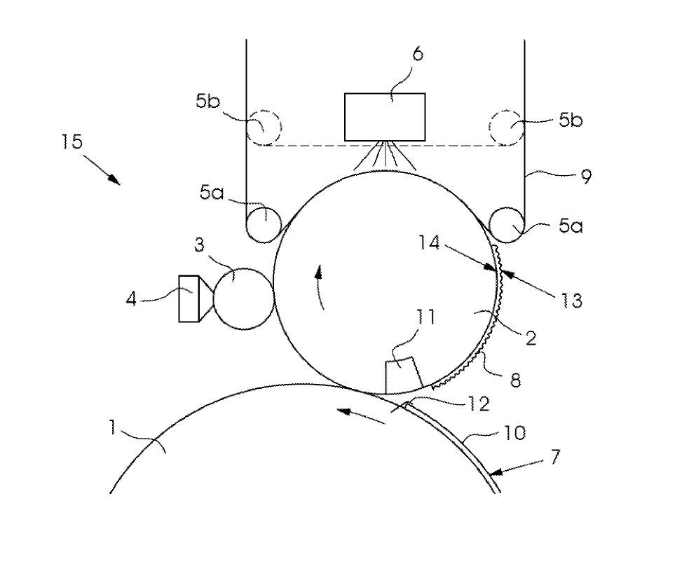

### CROSS-REFERENCE TO RELATED APPLICATION

This application claims the priority, under 35 U.S.C. §119, of German Patent Application DE 10 2012 021 819.2, filed Nov. 7, 2012; the prior application is herewith incorporated by reference in its entirety.

### BACKGROUND OF THE INVENTION

### Field of the Invention

The present invention relates to a method for coating sheets with a film in a printing press.

The upgrading, enhancing or finishing of printed products is gaining more and more importance. Printed products may be upgraded or enhanced by various finishing applications.

For example, U.S. Pat. No. 8,100,160 B2 describes a film transfer apparatus including a unit for applying glue and a unit for applying the film to the print sheet.

U.S. Pat. No. 8,105,455 B2 discloses a printing press including a printing unit with an integrated transfer unit. The printing unit may nevertheless be used for printing.

U.S. Pat. No. 8,136,563 B2 discloses a film transfer apparatus embodied as a cassette. When the film transfer apparatus is not in use, the cassette is pulled out of the printing unit.

U.S. Pat. No. 8,156,982 B2 discloses a film transfer unit wherein multiple webs of film are present.

In the devices described above, ready-made webs of film are used.

In contrast thereto, the method described in German Patent Application DE 100 22 939 A1, corresponding to U.S. Pat. No. 6,808,584, uses a film that is created in the printing press. In that method, a varnish is applied to a transfer roller and cured thereon using an UV radiator. Then glue is applied to the cured film of varnish to create a composite glue/varnish film. The composite film is transferred from the transfer roller to the print sheet.

German Patent DE 10 2008 028 949 B4, corresponding to U.S. Pat. No. 7,832,443, likewise describes the use of a UV-curable varnish. In that document, the varnish is applied to the sheet, and subsequently a film having an embossed pattern is pressed onto the applied varnish to transfer the pattern from the film to the varnish. Then the varnish is cured through the transparent film using a UV radiator. The pattern that is embossed into the varnish may be a hologram, for example.

A forming or molding process using a die or mold that carries the hologram as a relief surface structure is also described in German Patent Application DE 41 32 476 A1. The die or mold is disposed on a printing cylinder. A UV light source for curing the varnish is provided inside the printing cylinder. For that purpose, the printing cylinder and the die or mold are transparent to UV light. That forming or molding process is suitable for web-shaped printing material. The relief of the embossment structure created on the printing substrate is directed outward, away from the printing substrate. That makes the relief sensitive, in particular to contamination and abrasion.

### SUMMARY OF THE INVENTION

It is accordingly an object of the invention to provide a method for coating sheets with a film in a printing press, which overcomes the hereinafore-mentioned disadvantages of the heretofore-known methods of this general type.

With the foregoing and other objects in view there is provided, in accordance with the invention, a method for coating sheets with a film in a printing press. The method comprises a first step in which the film is formed in a liquid state on a first cylinder, a second step in which a web of foil is pressed onto the film, thus forming the surface of the film while simultaneously curing the film by irradiation, and a third step in which the film in the cured state is rolled onto a sheet by the first cylinder, with the sheet being transported by a second cylinder at the same time.

In accordance with the method of the invention, in the first step, a coating liquid is applied to the first cylinder to form a film thereon. The coating fluid may be a varnish, for example a clear varnish.

The coating fluid is preferably transparent. In the subsequent second step, a substantially tape-shaped foil formed of metal or a synthetic material, for example, and the fluid film applied to the first cylinder are brought into contact with each other, causing the surface of the film to be formed or molded, for example to be smoothened or structured. During the contact, radiation is applied to the formed surface in a targeted way to cure the film and to permanently stabilize the form of the surface. In the subsequent third step, the cured film is transferred from the first cylinder to the sheet. This is done under pressure in a cylinder nip formed by the first cylinder and the second cylinder.

In accordance with another mode of the invention, a blanket cylinder is used as the first cylinder. In this case, the cylinder nip formed by the first cylinder and the second cylinder is a so-called soft-roller nip.

In accordance with a further mode of the invention, in the first step, the film is applied to the first cylinder by a screen roller. The screen roller allows the fluid that will form the film on the first cylinder after it has been applied thereto to be accurately metered.

In accordance with an added mode of the invention, in the second step, a relief is molded into the film from the web of foil to create a structure in the film. The structure created in the film is the negative of the relief of the web of foil.

In accordance with an additional mode of the invention, the structure may be a hologram structure.

In accordance with yet another mode of the invention, in the third step, the film is rolled onto the sheet with the structure facing the sheet. In the multi-layer sandwich configuration formed by the film and the sheet after the film has been rolled on, the film surface that has been treated or formed or molded by the web of foil faces the sheet. Once the film has been bonded to the sheet, the other film surface, which is used to contact the first cylinder, faces outward and forms the visible surface of the sandwich configuration.

In accordance with yet a further mode of the invention, in the third step, the sheet is held and clamped by grippers of the second cylinder. The grippers grip the sheet at its leading edge. It is conceivable to use suction grippers instead of clamping grippers.

In accordance with yet an added mode of the invention, as the first cylinder and the second cylinder roll off on each other, the grippers temporarily dip into a cylinder gap of the first cylinder and the cylinder gap passes the web of foil as the first cylinder continues to rotate. In the process, the web of foil is wrapped around and contacts the first cylinder. If suction grippers or clamping grippers that do not extend beyond the circumference of the second cylinder are used, the cylinder gap may be dispensed with.

In accordance with yet an additional mode of the invention, in the third step, the film is glued onto the sheet using an adhesive that is applied to the sheet before the film. A varnish may be used instead of the glue. The adhesive may be UV-curable. After joining the film and the sheet, the adhesive located therebetween may be cured by UV radiation. The adhesive is preferably a material that is different from the film.

In accordance with a concomitant mode of the invention, in the second step, the film is irradiated through the web of foil to be cured or hardened. Preferably, the film is irradiated with UV radiation in the second step to cure the film. The web of foil may be made of a transparent synthetic material that allows the UV radiation to pass through.

Other features which are considered as characteristic for the invention are set forth in the appended claims.

Although the invention is illustrated and described herein as embodied in a method for coating sheets with a film in a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

The FIGURE of the drawing is a fragmentary, diagrammatic, cross-sectional view of a finishing unit including a device for coating sheets with a film.

### DETAILED DESCRIPTION OF THE INVENTION

Referring now in detail to the single FIGURE of the drawing, there is seen a section of a sheet-fed printing press for lithographic offset printing. The section shows a finishing unit 15 of the printing press. The finishing unit 15 is provided in addition to lithographic offset printing units and includes an impression cylinder 1 having grippers 12 for transporting sheets 10. The impression cylinder 1 cooperates with a transfer or blanket cylinder 2 that has a cylinder gap 11. The grippers 12 temporarily dip into the cylinder gap 11 with each revolution of the cylinders. A screen roller 3 and a chambered doctor blade 4 together form an application device for applying a UV-curable varnish to the blanket cylinder 2. The application device is provided downstream of a nip of the cylinders 1, 2. A web of foil 9, which may be endless or may be wound on and off, is provided downstream of the application device. The web of foil 9 has a relief for embossing or molding a pattern, hologram or the like into a layer or film of varnish 8 applied by the application device and thus acts as a die or mold. The web of foil 9 is guided by two pressure rollers 5a, which press the web of foil 9 against the blanket cylinder 2 in a contact section. In the process, the relief of the web of foil 9 is pressed into the film of varnish 8 applied to the blanket cylinder 2, causing the varnish to receive a molded or embossed structure. During the process, the web of foil 9 runs at a synchronous speed substantially corresponding to the circumferential speed of the impression cylinder 1, which means that no speed difference occurs between the film of varnish and the web of foil. In the region of the contact section, a UV source 6 or a UV drier is provided to cure or fix the embossed structure through the web of foil 9. For this purpose, the web of foil 9 is made of a material that is transparent to UV light. As the blanket cylinder 2 continues to rotate, the layer of varnish 8, with its structured side 13 structured by the embossment facing outward, is transported outward to the entry of the nip formed by the cylinders 1, 2. The sheet 10, which has an outward-facing side that has been coated with glue 7, is also transported to this location. In order to coat the sheet 10 with glue 7, an application unit, for example a printing or varnishing unit that has been modified for this purpose and is not illustrated herein, is provided upstream of the finishing unit 15. After the embossment, the structured side 13 faces outward, i.e. towards the sheet 10 that is moving toward the web of foil 9. A smooth side 14 of the film of varnish 8 rests on the blanket cylinder 2. In the nip, the film of varnish 8 is transferred to the sheet 10, with the structured side 13 being pressed into the adhesive 7. The fact that the film of varnish 8 is glued onto the sheet 10 on its structured side 13 results in a particularly firm bonding. Another result is that the smooth side 14 of the film of varnish 8 faces outward on the completely finished sheet 10. This smooth side 14 is resistant to soiling and damage by contact. The delicate structured side 13 faces inward and is thus protected.

The phantom lines indicate the web of foil 9 and the pressure rollers in their passive positions in which they are withdrawn from the blanket cylinder 2. In this passive position, the pressure rollers are indicated by reference symbol “5b.” The web of foil 9 is no longer wrapped around the blanket cylinder 2 and is spaced apart from the latter. The pressure rollers are selectively movable into the active position 5a and into the passive position 5b. When the sheets are not to be enhanced by embossed films of varnish, the pressure rollers are in the passive position 5b.

An advantage of the indirect transfer of the embossed structure of the web of foil 9 onto the sheet 10 by using the transfer cylinder or blanket cylinder 2 is that the web of foil 9 does not directly cooperate with the impression cylinder 1 that is provided with grippers 12. Instead, the web of foil directly cooperates with the blanket cylinder 2, which does not have grippers, avoiding damage to the web of foil 9 by grippers. Possible damage to the web of foil 9 caused by the sheet 10, which is transported onto the impression cylinder 1, hitting the web of foil 9, is likewise prevented.

The circumferential blanket surface of the blanket cylinder 2, which is also referred to as the first cylinder, ought to be made of a UV-resistant synthetic material. Alternatively, the first cylinder 2 may have a hard, e.g. metallic circumferential surface, and the impression cylinder 1, which may also be referred to as the second cylinder, may have a soft, resilient circumferential surface, for example made of rubber or a synthetic material.

1. A method for coating sheets with a film in a printing press, the method comprising the following steps:
in a first step, creating the film in a liquid state on a first cylinder;
in a second step, pressing a web of foil onto the film, causing a surface of the film to be formed, and simultaneously curing the film by irradiation; and
in a third step, rolling the film in a cured state onto a sheet using the first cylinder, while transporting the sheet using a second cylinder.

2. The method for coating sheets with a film in a printing press according to claim 1, which further comprises using a blanket cylinder as the first cylinder.

3. The method for coating sheets with a film in a printing press according to claim 1, which further comprises, during the first step, applying the film to the first cylinder using a screen roller.

4. The method for coating sheets with a film in a printing press according to claim 1, which further comprises, during the second step, molding a relief into the film using the web of foil to create a structure in the film.

5. The method for coating sheets with a film in a printing press according to claim 4, wherein the structure is a hologram structure.

6. The method for coating sheets with a film in a printing press according to claim 4, which further comprises, during the third step, rolling the film onto the sheet with the structure facing the sheet.

7. The method for coating sheets with a film in a printing press according to claim 1, which further comprises, during the third step, clamping and holding the sheet in grippers of the second cylinder.

8. The method for coating sheets with a film in a printing press according to claim 7, which further comprises:
temporarily dipping the grippers into a cylinder gap of the first cylinder as the first cylinder rolls on the second cylinder; and
carrying out a course of further rotation of the first cylinder in which the cylinder gap passes the web of foil, with the web of foil in wrapped-around contact with the first cylinder.

9. The method for coating sheets with a film in a printing press according to claim 1, which further comprises, during the third step, gluing the film onto the sheet using an adhesive applied to the sheet before applying the film.

10. The method for coating sheets with a film in a printing press according to claim 1, which further comprises, during the second step, irradiating and thus curing the film through the web of foil.

11. The method for coating sheets with a film in a printing press according to claim 1, which further comprises, during the second step, irradiating the film with UV radiation and thus curing the film.
